(19) United States
(12) Patent Application Publication
(10) Pub. No.: US 2026/0002829 A1
(43) Pub. Date: Jan. 1, 2026

(54) VEHICLE LEAK DETECTION APPARATUS AND METHOD WITH AUTOMATIC INTAKE PRESSURE REGULATION

(71) Applicant: Evan Kwong, Monterey Park, CA (US)

(72) Inventor: Evan Kwong, Monterey Park, CA (US)

(21) Appl. No.: 18/759,911

(22) Filed: Jun. 30, 2024

(51) Int. Cl. G01M 3/20; F16K 15/04

(52) U.S. Cl. CPC G01M 3/20; F16K 15/044

(57) ABSTRACT

The present disclosure provides a vehicle leak detection apparatus with automatic intake pressure regulation, comprising: an air pump; a first pipeline configured to allow air pumped by the air pump to be pumped into a test vehicle; a smoke generation unit arranged between the air pump and the test vehicle and configured to generate visible smoke in the air pumped into the test vehicle; and a check valve removably connected to the first pipeline and configured to release air after an air pressure in the first pipeline exceeds an intake pressure that the check valve can withstand so as to automatically regulate the intake pressure during vehicle leak detection.

### TECHNICAL FIELD

The present disclosure relates to the technical field of vehicle leak detection, and in particular, to a vehicle leak detection apparatus and method with automatic intake pressure regulation.

### BACKGROUND ART

The determination of a sealing problem with an intake system of a vehicle can be made by means of filling the entire intake system with smoke and observing whether there is a smoke leakage, and air pressurization is also commonly used to test the sealing performance.

At present, in a vehicle leak detection device, air pressure regulation is implemented by means of opening and closing actions of a pressure regulating valve arranged between an air inlet and an air outlet.

### SUMMARY

According to embodiments of the present disclosure, a vehicle leak detection apparatus and method with automatic intake pressure regulation are provided, in order to solve the problems existing in the related art and to achieve regulation of different intake pressures through replacement of a check valve, significantly reducing costs. The technical solution is described as follows.

According to some embodiments of the present disclosure, a vehicle leak detection apparatus capable of regulating an intake pressure is provided. The vehicle leak detection apparatus comprises:
an air pump;
a first pipeline configured to allow air pumped by the air pump to be pumped into a test vehicle;
a smoke generation unit arranged between the air pump and the test vehicle and configured to generate visible smoke in the air pumped into the test vehicle; and
a check valve connected to the first pipeline and configured to release air after an air pressure in the first pipeline exceeds an intake pressure that the check valve is capable of withstanding so as to automatically regulate the intake pressure during vehicle leak detection.

According to some embodiments of the present disclosure, a vehicle leak detection method with automatic intake pressure regulation is further provided, which uses a vehicle leak detection apparatus with automatic intake pressure regulation as described in the above embodiments. The vehicle leak detection method comprises the following steps:
selecting a check valve corresponding to an appropriate intake pressure according to the type of an intake system of a test vehicle, and connecting the check valve to a first pipeline;
starting an air pump and a smoke generation unit;
pumping air pumped by the air pump into the test vehicle; and
observing whether there is visible smoke in the test vehicle, and then determining an air leakage location.

The above description is merely presented for the purpose of the specification, and is not intended to limit the present disclosure in any way. Except for the above illustrative aspects, implementations and features, further aspects, implementations and features of the present disclosure will become readily apparent with reference to the accompanying drawings and the following detailed description.

### BRIEF DESCRIPTION OF THE DRAWINGS

In figures, the same reference signs denote the same or similar components or elements throughout multiple figures unless otherwise specified. These figures are not necessarily drawn to scale. It should be understood that these figures depict only some implementations according to the present disclosure and are not to be construed as limiting the scope of the present disclosure.

FIG. 1 is a schematic diagram of a vehicle leak detection apparatus 100 with automatic intake pressure regulation according to an embodiment of the present disclosure;

FIG. 2 is a structural diagram of a diaphragm check valve used in an embodiment of the present disclosure;

FIG. 3 is a cross-sectional view of the diaphragm check valve of FIG. 2 taken along line A-A;

FIG. 4 is a structural diagram of a spring check valve used in an embodiment of the present disclosure;

FIG. 5 is a cross-sectional view of the spring check valve of FIG. 4 taken along line A-A;

FIG. 6 is a structural diagram of a ball check valve used in an embodiment of the present disclosure;

FIG. 7 is a cross-sectional view of the ball check valve of FIG. 6 taken along line A-A;

FIG. 8 is a flowchart of steps of a vehicle leak detection method with automatic intake pressure regulation according to an embodiment of the present disclosure.

### DETAILED DESCRIPTION OF EMBODIMENTS

Only some exemplary embodiments are briefly described below. As can be appreciated by those skilled in the art, modifications may be made to the described embodiments in various ways without departing from the spirit or scope of the present disclosure. Therefore, the accompanying drawings and the description are considered as exemplary in nature rather than limiting.

When the sealing performance is tested by means of air pressurization, the regulation is based on the pressure difference between an air inlet and an air outlet, thus it is necessary to measure air pressures at the air inlet and the air outlet or the pressure difference between the air inlet and the air outlet. Since different intake systems, such as an air conditioning system or a fuel system, of a vehicle are subject to limitations on the maximum air pressure, an intake pressure output by a leak detection device also needs to be regulated. This results in high cost of implementation of the air pressure regulation method, a relatively large size of the leak detection device, and easy damage to the vehicle intake system due to incorrect operations.

FIG. 1 shows a vehicle leak detection apparatus 100 with automatic intake pressure regulation according to a preferred implementation of the embodiments of the present disclosure. The apparatus comprises:
an air pump 1;
a first pipeline 2 configured to allow air pumped by the air pump 1 to be pumped into a test vehicle 5;
a smoke generation unit 3 arranged between the air pump 1 and the test vehicle 5 and configured to generate visible smoke in the air pumped into the test vehicle; and
a check valve 4 connected to the first pipeline 2 and configured to release air after an air pressure in the first pipeline 2 exceeds an intake pressure that the check valve 4 can withstand so as to automatically regulate the intake pressure during vehicle leak detection.

In order to perform leak detection for different intake systems, such as an air conditioning system or a fuel system, in the test vehicle, the air pump is used to test the sealing performance of the different intake systems in the vehicle under different pressures. Therefore, pressure relief can be achieved by using the check valve 4, and since the check valve according to the pressure withstanding range can be selected in advance, it is less likely to damage the intake system during detection; and there is no need to provide a switch for air pressure regulation or to provide modules for setting, for example, air pressures at the air outlet of the air pump, reducing costs and achieving more convenient operation.

In an embodiment, as shown in FIG. 1, a second pipeline 6 is further included, the check valve 4 is connected to the first pipeline 2 via the second pipeline 6, and the check valve 4 is removably or integrally connected to the second pipeline 6. In this way, the regulation of air pressure in the first pipeline 2 can be achieved through replacement of the check valve 4, thereby achieving automatic regulation of the intake pressure of the test vehicle. In this embodiment, the first pipeline 2 and the second pipeline 6 may be integrally formed to achieve connection.

The smoke generation unit 3 may use dry ice or vapor to achieve “smoke generation”.

In some alternative embodiments, the second pipeline 6 is removably or integrally connected to the first pipeline 2, and the first pipeline 2 and the second pipeline 6 can be removably and hermetically connected to each other, for example, by means of threaded connection or insertion.

In an embodiment, the smoke generation unit 3 is arranged between the air pump 1 and the second pipeline 6 and is connected to the first pipeline 2 to enable visualization of air release of the check valve 4. Since the smoke generated by the smoke generation unit 3 is first delivered into the first pipeline 2, after the air pressure exceeds the intake pressure that the check valve 4 located at the back can withstand, the air released after the check valve 4 is opened also contains smoke, which can be visually observed. In addition, the check valve 4 is also closed after the intake pressure in the first pipeline 2 is less than the intake pressure that the check valve 4 can withstand.

In an embodiment, the air pump 1 may be a straightway air pump or be of other air-pressurization types that can provide pressurization. Compared with the prior art, the air pump 1 may be an air pump without a function of regulating the output air pressure.

In an embodiment, the check valve 4 may be of different types or specifications to be capable of withstanding different intake pressures, that is, to meet requirements for different intake pressures of the test vehicle, wherein the check valve is capable of withstanding an intake pressure of 0.5 Kpa-15 Kpa.

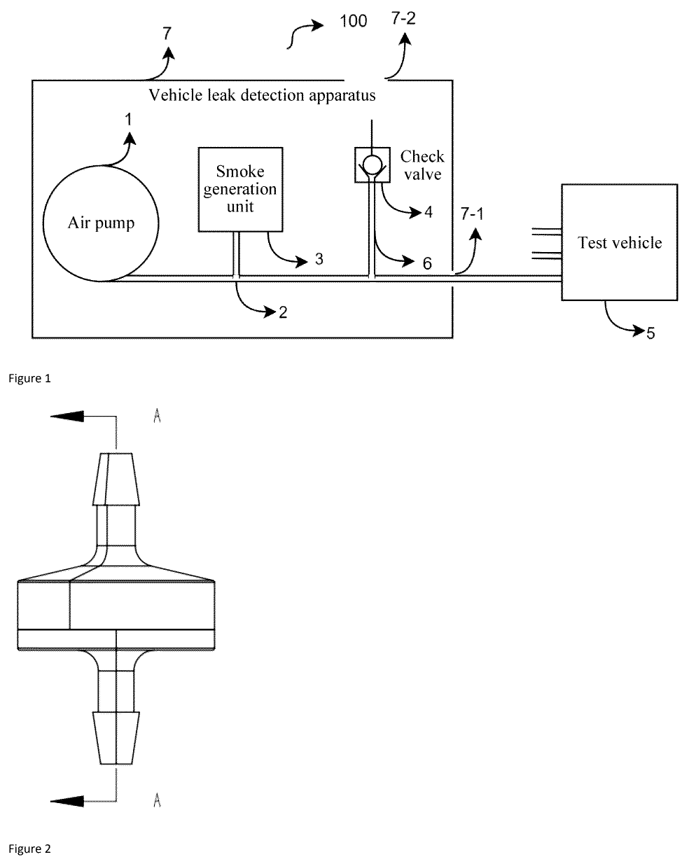

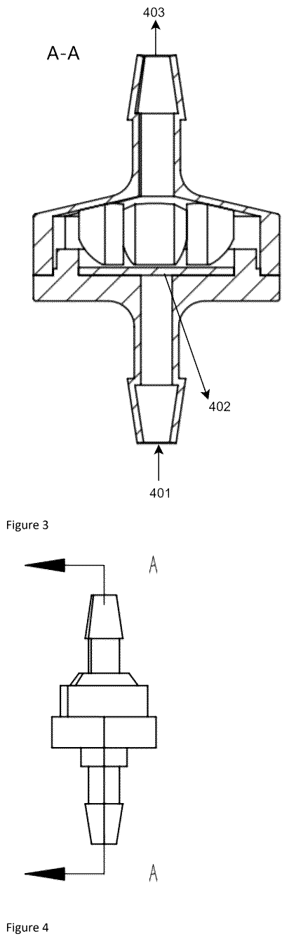

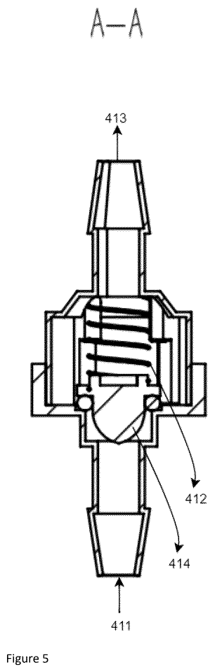

In an embodiment, the check valve 4 may be a diaphragm check valve. FIG. 2 shows a diaphragm check valve used in an embodiment of the present disclosure, and FIG. 3 is a cross-sectional view of FIG. 2 taken along line A-A. Airflow enters from an air inlet 401. When the intake pressure exceeds the sealing pressure that a diaphragm structure 402 can withstand, one-way opening of the valve is achieved, that is, the airflow can pass from the air inlet 401 to an air outlet 403 to achieve pressure relief. The intake pressure that the diaphragm structure 402 can withstand is relatively small, and the thickness of the diaphragm structure 402 can be adjusted to change the intake pressure that the valve can withstand, which can usually be regulated to about 0.5 kPa.

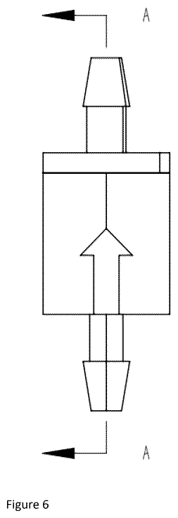

In an embodiment, the check valve 4 may also be a spring check valve. FIG. 4 shows a spring check valve used in an embodiment of the present disclosure, and FIG. 5 is a cross-sectional view of the spring check valve taken along line A-A. Airflow enters from an air inlet 411. When an intake pressure exceeds the sealing pressure that a first spring 412 can withstand, a plug head 414 pushes the first spring 412 to move upward to achieve pressure relief to achieve one-way opening of the valve, that is, the airflow can pass from the air inlet 411 to an air outlet 413 to achieve pressure relief. The tightness of the first spring 412 can be adjusted to preset the intake pressure that the valve can withstand, which can usually be regulated to about 5 kPa.

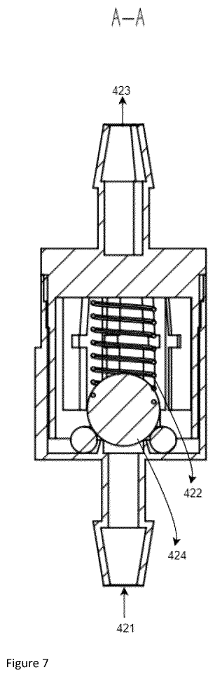

In an embodiment, the check valve 4 may also be a ball check valve. FIG. 6 shows a ball check valve used in an embodiment of the present disclosure, and FIG. 7 is a cross-sectional view of the ball check valve taken along line A-A. Airflow enters from an air inlet 421. When an intake pressure exceeds the sealing pressure that a second spring 422 can withstand, a ball head 424 pushes the second spring 422 to move upward to achieve pressure relief to achieve one-way opening of the valve, that is, the airflow can pass from the air inlet 421 to an air outlet 423 to achieve pressure relief. The tightness of the second spring 422 can be adjusted to preset the intake pressure that the valve can withstand, which can usually be regulated to about 8 kPa.

In an embodiment, a housing 7 is further included, and the housing 7 is configured to accommodate the air pump 1, the smoke generation unit 3, at least part of the first pipeline 2, and at least part of the check valve 4. The housing accommodates the modules mentioned above to achieve portability. Of course, by means of the housing 7 described above, switches or power sources involved in the modules are accessible to a user from outside the housing.

In an embodiment, the housing 7 has a first outlet 7-1 from which the first pipeline 2 at least partially extends out, which facilitates connection between the first pipeline 2 and the test vehicle.

In an embodiment, the housing 7 has a second outlet 7-2 through which the second pipeline 6 or the check valve 4 is at least partially accessible from outside the housing, which facilitates replacement with a check valve 4 of different specifications or types through the second outlet 7-2. In an optional implementation, the second outlet 7-2 may also be configured such that the second pipeline 6 or the check valve 4 partially extends out of the housing, which can also facilitate replacement of the check valve 4.

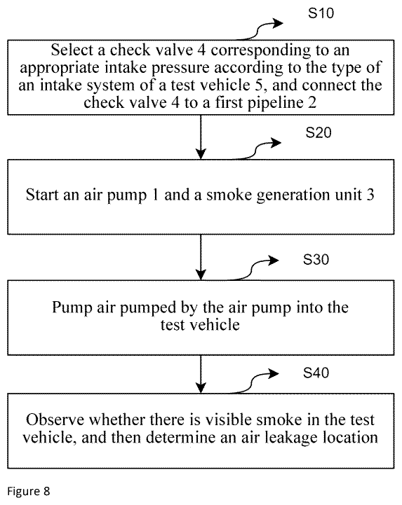

An embodiment of the present disclosure further provides a vehicle leak detection method with automatic intake pressure regulation, which uses the vehicle leak detection apparatus 100 with automatic intake pressure regulation with automatic intake pressure regulation in the above embodiments. As shown FIG. 8, the method comprises the following steps.

At step S10, a check valve 4 corresponding to an appropriate intake pressure is selected according to the type of an intake system of a test vehicle 5, and the check valve 4 is connected to a first pipeline 2. For example, when the intake system in the test vehicle is an air conditioning system, a check valve that can withstand an intake pressure of 5 kPa may be used.

At step S20, an air pump 1 and a smoke generation unit 3 are started. For example, the air pump 1 and the smoke generation unit 3 may be started by manually turning on switches, or may be started with one button in a more intelligent way, and intelligent control may be achieved by linking the switches that start the air pump 1 and the smoke generation unit 3 or by implementing soft start, etc.

At step S30, air pumped by the air pump is pumped into the test vehicle. The first pipeline 2 is connected to the intake system of the test vehicle 5, and the air with smoke is pumped into the intake system to implement air leakage detection.

At step S40, an observation is made to determine whether there is visible smoke in the test vehicle and then determine the air leakage location. For example, the air leakage location is determined by means of observing whether smoke appears at a location other than the outlet in the entire intake system.

In an embodiment, the check valve 4 is a diaphragm check valve, a spring check valve, or a ball check valve.

For example, the check valve 4 can withstand an intake pressure of 0.5 kPa as a diaphragm check valve.

For example, the check valve 4 can withstand an intake pressure of 5 kPa as a spring check valve.

For example, the check valve 4 can withstand an intake pressure of 8 kPa as a ball check valve.

In the description of this specification, descriptions with reference to the terms such as “an embodiment”, “some embodiments”, “example”, “specific example”, or “some examples” mean that specific features, structures, materials, or characteristics described with reference to the embodiment or example are included in at least one embodiment or example of the present disclosure. Moreover, the specific features, structures, materials or characteristics described can be combined in any one or more embodiments or examples in any suitable manner. In addition, without any contradiction, those skilled in the art may incorporate and combine different embodiments or examples and features of the different embodiments or examples described in this specification.

In addition, the terms “first” and “second” are used for descriptive purposes only, and cannot be construed as indicating or implying relative importance or implicitly indicating the number of technical features indicated. Thus, the features defined with “first” and “second” may explicitly or implicitly include at least one of the features. In the description of the present disclosure, the meaning of “a plurality of” is two or more, unless explicitly and specifically defined otherwise.

The above descriptions are merely specific implementations of the present disclosure, but are not intended to limit the scope of protection of the present disclosure. Any variation or replacement readily figured out by those skilled in the art within the technical scope disclosed in the present disclosure shall fall within the scope of protection of the present disclosure. Therefore, the scope of protection of the present disclosure shall be subject to the scope of protection of the claims.

1. A vehicle leak detection apparatus with automatic intake pressure regulation, comprising:
an air pump;
a first pipeline configured to allow air pumped by the air pump to be pumped into a test vehicle;
a smoke generation unit arranged between the air pump and the test vehicle and configured to generate visible smoke in the air pumped into the test vehicle; and
a check valve includes a first end which is connected to the first pipeline and a second end which is connected to atmosphere, the check valve is configured to release air from the first end to the second end when an air pressure in the first pipeline exceeds an intake pressure that the check valve is capable of withstanding so as to automatically regulate the intake pressure during vehicle leak detection;
wherein the check valve is capable of withstanding an intake pressure of 0.5 Kpa-15 Kpa;
a second pipeline, wherein the check valve is connected to the first pipeline via the second pipeline, and the check valve is removably connected to the second pipeline or the second pipeline is removably connected to the first pipeline;
wherein the smoke generation unit is arranged between the second pipeline and the test vehicle;
wherein the smoke generation unit is removably connected to the first pipeline;
wherein the check valve is a diaphragm check valve, a spring check valve, or a ball check valve.

2. (canceled)

3. The vehicle leak detection apparatus with automatic intake pressure regulation according to claim 1, wherein the smoke generation unit is arranged between the air pump and the second pipeline and connected to the first pipeline to enable visualization of air release of the check valve.

4. (canceled)

5. (canceled)

6. (canceled)

7. The vehicle leak detection apparatus with automatic intake pressure regulation according to claim 1, further comprising a housing configured to accommodate the air pump, the smoke generation unit, at least part of the first pipeline, and at least part of the check valve.

8. The vehicle leak detection apparatus with automatic intake pressure regulation according to claim 7, wherein the housing has a first outlet from which the first pipeline at least partially extends.

9. The vehicle leak detection apparatus with automatic intake pressure regulation according to claim 7, wherein the housing has a second outlet through which the check valve is at least partially accessible from outside the housing.

10. (canceled)

11. The vehicle leak detection apparatus with automatic intake pressure regulation according to claim 1, further comprising a housing configured to accommodate the air pump, at least part of the first pipeline, and at least part of the check valve.

12. (canceled)

13. A vehicle leak detection method with automatic intake pressure regulation, which uses a vehicle leak detection apparatus with automatic intake pressure regulation according to claim 1, the method comprising the following steps:
selecting a check valve corresponding to an appropriate intake pressure according to the type of an intake system of a test vehicle, and connecting the check valve to a first pipeline;
starting an air pump and a smoke generation unit;
pumping air pumped by the air pump into the test vehicle; and
observing whether there is visible smoke in the test vehicle, and then determining an air leakage location.

14. (canceled)

15. (canceled)
